(19) United States
(12) Patent Application Publication
(10) Pub. No.: US 2003/0037895 A1
(43) Pub. Date: Feb. 27, 2003

(54) Pigments used to produce paper

(76) Inventors: Rudolf Lunkenheimer, Wackenheim (DE); Hein-Willi Weih, Ludwigshafen (DE); Hasan Ulubay, Schauernheim (DE); Bernd Schutzius, Romerberg (DE)

Correspondence Address: VENABLE, BAETJER, HOWARD AND CIVILETTI, LLP, P.O. BOX 34385, WASHINGTON, DC, 20043-9998, US

(21) Appl. No.: 10/220,122

(22) PCT Filed: Dec. 19, 2001
(86) PCT No.: PCT/EP01/15075

(30) Foreign Application Priority Data
Dec. 28, 2000 (DE) 10065583.1

(51) Int. Cl. C09C 1/62; D21H 17/66; D21H 17/67; D21H 19/38

(52) U.S. Cl. 162/181.3; 106/404; 162/135; 162/181.5

(57) ABSTRACT

The invention concerns sulfate-containing and aluminum-containing pigments having pseudoboehmitic structural units, their manufacture and use for paper making. In the manufacture of paper, these pigments produce surprisingly good printing results with inkjet color printers and are also simple to manufacture.

The invention concerns sulfate-containing and aluminum-containing pigments having pseudoboehmitic structural units, their manufacture and use for paper making.

In the field of laser and inkjet printers, the printing inks still produce widely varying print images with regard to quality despite the technological progress made with inks and with printers, depending in each individual case on the paper type and the paper coating.

A good print image is distinguished, for instance, by a low level of wicking (running of the ink into the unprinted paper), minimal bleeding (running of two colors into one another), a small amount of mottling (unevenness of the color density in a printed area), high brilliance and a high level of point sharpness.

For these reasons, special papers are offered for use with inkjet printers whereby the base of the coating mainly comprises pigments, color fixers and binders. As pigments, for instance, aerosils, precipitated silicic acids, aluminum oxides, hydrous aluminum oxides and aluminum hydroxides are used. Very good printing quality is achieved with use of aerosils, aluminum oxides and hydrous aluminum oxides mixed with other auxiliary agents. The disadvantage of these pigments lies in their high price, resulting from the heavy manufacturing costs.

JP 10 181,192 (from CA Selects: Paper Additives, Issue 118, 1998, 129: 88055n) describes, for instance, a paper coated with Al₂O₃, distinguished by its water-resistance and sharp printed images. In JP 1191,235 (from CA Selects: Paper Additives, Issue 11, 1999, 130: 274144m), an color-absorbing layer is described which contains γ- and/or δ-Al₂O₃ in combination with a non-aqueous binder. This layer is distinguished by its rapid and extensive color absorption, surface gloss and water-resistance. In EP 0691210 B1, a recording material is claimed which encompasses a hydrous aluminum oxide with at least two peaks in the pore radius distribution, whereby one of the peaks is localized at less than 10 nm and the other occurs within a range of 10 to 20 nm, and the hydrous aluminum oxide is defined by the following general formula:

Al₂O₃₋ₙ(OH)₂ₙ.mH₂O

where n is a whole number value of 0, 1, 2 or 3 and m is a number between 0 and 10, subject to the condition that m and n are not simultaneously 0.

The hydrous aluminum oxides are produced in a complex process, according to U.S. Pat. No. 4,242,271 and U.S. Pat. No. 4,202,870, from aluminum alkoxides.

EP 0761459 A1 describes an inkjet recording medium which comprises two layers, whereby the lower layer is made from porous hydrous aluminum oxide with a layer thickness of 1 to 200 μm and the upper layer from a water-soluble resin with a layer thickness of between 0.01 μm and 50 μm. The hydrous aluminum oxides are also made from aluminum alkoxides in this case.

The aim was therefore to make an inexpensive pigment available on the market with which, particularly by mixing with other auxiliary agents, a recording medium having excellent inkjet suitability may be made.

It has been possible to fulfil the aim with sulfur-containing and aluminum-containing pigments having pseudoboehmitic structural units characterized in that they have the following empirical formula

Alₐ(O)_{b}(OH)_{c}(R)_{d}(SO₄)ₑ.yH₂O

where

a. 2b+c+xd+2e=3a and

b. a≧1, b>0, c>0, d≧0, e>0 and

c. 2b+c≧1.5 a and

d. x≧1 and

e. y=0−15 and

f. R represents a monobasic or polybasic anion or mixtures of at least two anions and x is the charge on the anion, as a positive number, whereby in the case of mixtures of anions xd=x₁d₁+x₂d₂+ . . . +xₙdₙ.

As additional anions R, the aluminum compounds preferably contain the anions of hydrochloric acid, phosphoric acid, nitric acid, carbonic acid, ethanoic acid, formic acid, lactic acid, glycolic acid and mixtures of these.

The sulfate-containing and aluminum-containing pigments are obtainable with a process that is characterized by

a. a basic aluminum salt or mixtures of basic aluminum salts or

b. an aluminum hydroxide and/or a basic aluminum salt or mixtures of these with an acid or mixtures of acids or

c. a basic aluminum salt or mixtures of basic aluminum salts in the presence of compounds containing quatemary ammonium groups or

d. an aluminum hydroxide and/or a basic aluminum salt or mixtures of these with an acid or mixtures of acids in the presence of compounds containing quatemary ammonium groups or

e. a basic aluminum salt or mixtures of basic aluminum salts with a salt of an acid or with mixtures of salts of acids or

f. a basic aluminum salt or mixtures of basic aluminum salts with a salt of an acid or with mixtures of salts of acids in the presence of compounds containing quaternary ammonium groups are reacted in water at raised temperature,

whereby under points a. to f. the sulfate anion is introduced into the aluminum compound via the basic aluminum salt and/or via sulfuric acid or its salts.

The pigments according to the invention are produced as finely divided suspensions, which may be used as such or dried.

As basic aluminum salts, preferably basic aluminum carbonates, basic aluminum chlorides, basic aluminum sulfates, basic aluminum phosphates, basic aluminum nitrates, basic aluminum acetates, basic aluminum formiates, basic aluminum carbonate chlorides, basic aluminum carbonate sulfates, basic aluminum carbonate phosphates, basic aluminum carbonate nitrates, basic aluminum carbonate acetates, basic aluminum carbonate formiates and their mixtures are used.

Basic aluminum salts are known from the prior art. They may be produced, for instance, by precipitation reactions from aluminum sulfate or aluminum chloride with bases. It is also possible to manufacture the basic aluminum salts with a salt-forming reaction from basic aluminum salts such as, for instance, basic aluminum chlorides with a salt of an acid or with mixtures of salts of acids. For incorporation of the carbonate anion, the reactions are carried out in the presence of CO₂ or the salts of carbonic acid. With this method, basic aluminum carbonates, basic aluminum chlorides, basic aluminum sulfates, basic aluminum phosphates, basic aluminum nitrates, basic aluminum acetates, basic aluminum formiates, basic aluminum carbonate chlorides, basic aluminum carbonate sulfates, basic aluminum carbonate phosphates, basic aluminum carbonate nitrates, basic aluminum carbonate acetates, basic aluminum carbonate formiates or other mixed salts of aluminum may be made.

The precipitated material is generally filtered and washed, so that a wet filter cake is produced, which may also be dried. The basic aluminum compounds thus produced are X-amorphous (see FIG. 2) and are not suitable, even in combination with other auxiliary agents, as coating materials for inkjet-compatible papers.

Only after thermal treatment of the filter cake or of the dried filter cake, preferably of the filter cake dispersed in water, at high temperatures, preferably at 80°-150° C. over a period of 0.5-36 hours, preferably 1-12 hours, is a material produced which in combination with other auxiliary agents is suitable as a coating material for papers for laser and inkjet printers. Particularly suitable are the pigments according to the invention with pseudoboehmitic structural units, which are obtained by thermal treatment of a basic aluminum compound in the presence of inorganic and/or organic acids and/or quaternary compounds bearing ammonium groups. As inorganic acids, preferably hydrochloric acid, sulfuric acid, phosphoric acid, nitric acid, amidosulfuric acid are used; as organic acids, preferably ethanoic acid, betaine hydrochloride, formic acid, lactic acid glycolic acid are used; as compounds bearing quaternary ammonium groups, preferably homopolymers and copolymers of diallyldimethylammonium chloride, dimethylamine/epichlorohydrin condensation products and betaine are used. The acids are used in quantities such that the alkalinity of the aluminum compounds in the end product is ≧50%.

Thus, for instance, a coating material may be produced in that a basic aluminum carbonate sulfate with a proportion by weight of CO₂ of between 1% and 20% relative to Al₂O₃ and a proportion by weight of sulfate of between 5% and 20% relative to Al₂O₃ with hydrochloric acid in such a quantity that the proportion by weight of HCl is between 1% and 15% relative to Al₂O₃, and an organic carboxylic acid in such a quantity that the proportion by weight of organic carboxylic acid is between 0% and 50% relative to Al₂O₃, is reacted in water at temperatures of up to 150° C. over a period of 30 to 720 min, whereby the Al₂O₃ content of the mixture is up to 18%, and subsequently, if necessary after cooling, further auxiliary agents are mixed into the suspension.

According to the XRD images (see FIGS. 1 and 3), pseudoboehmitic structures are present, whereby pseudoboehmites are to be understood as boehmites that have a high proportion of water in their crystal structure, as well crystallized boehmites. According to Edisson Margado Jr. et al. (Journal of Colloid and Interface Science 188, 257-269, 1997) and the literature cited in their article, boehmites do not differ from pseudoboehmites with regard to their physical and chemical structure.

The thermal treatment may also be carried out in the presence of the auxiliary agents, such as polycations, polyhydroxy compounds, polyethers, polyamides or their salts, binders and their mixtures.

Aluminum-containing pigments made in this way represent a base material for coatings. They may, also in mixtures with auxiliary agents, be mechanically treated subsequently as needed, for instance by grinding, high pressure homogenizing or through treatment with an Ultraturrax. They provide, particularly in mixtures with auxiliary agents such as polycations, polyhydroxy compounds, polyethers, polyamines and their salts, binding agents and their mixtures, excellent print images with inkjet printing with regard to wicking, bleeding, mottling, brilliance and point sharpness.

As polycations, preferably homopolymers and copolymers of diallyldimethylammonium chloride, dimethylamine/epichlorohydrin condensation products, polyamidamine/epichlorohydrin resins, as polyhydroxy compounds preferably polyvinyl alcohols, starch, modified starch, modified celluloses, as polyethers preferably homopolymers and copolymers of ethylene oxide and propylene oxide, and as polyamines preferably polyvinylamines and their salts, made from polyvinylformamides with different degrees of hydrolysis are used.

As binders, different cationic, amphoteric, anionic types and their mixtures may be used, provided they are compatible. Anionic binders can only be used if they do not make application of the coating with a coating assembly, a film press, a speedsizer or a size press impossible due to unfavorable rheological properties. As binders, for instance starch, starch derivatives, cellulose derivatives, such as carboxymethyl cellulose and hydroxyethyl cellulose, casein, gelatin, polyvinyl alcohols and their derivatives, acrylate copolymers, styrene/butadiene copolymers, styrene/acrylate copolymers, polymers grafted onto starch, polyurethanes, polyester resins, vinyl chloride/vinyl acetate copolymers, and mixtures of these.

The invention will now be described in greater detail with the aid of examples.

### EXAMPLE 1

In a 500 ml double-jacket reactor with a reflux condenser and a stirrer, 305.3 g of a basic aluminum carbonate sulfate as a wet cake (Al₂O₃:13.1%, CO₂:1.44%, SO₄²⁻:1.3%) was suspended in 94.7 g water and heated, stirred intensively for 6 hours at 95° C. and then cooled. A finely divided dispersion with a pH value of 6.24 resulted.

The XRD image revealed that the product comprised an amorphous aluminum compound with pseudoboehmitic structural units (see FIG. 1), whereas the filter cake used was X-amorphous (see FIG. 2).

### EXAMPLE 2

In a 500 ml double-jacket reactor with a reflux condenser and a stirrer, 305.3 g of a basic aluminum carbonate sulfate as a wet cake (Al₂O₃: 13.1%, CO₂: 1.44%, SO₄²⁻: 1.3%) was suspended in 80.75 g water. 13.95 g of a 32% HCl solution was added to the suspension, it was heated and stirred intensively for 6 hours at 95° C., then cooled. A finely divided dispersion with a pH value of 4.0 resulted.

The XRD image revealed that the product comprised an amorphous aluminum compound with pseudoboehmitic structural units (see FIG. 3).

### EXAMPLE 3

In a 500 ml double-jacket reactor with a reflux condenser and a stirrer, 151.2 g of a basic aluminum carbonate sulfate as a wet cake (Al₂O₃: 13.27%, CO₂: 1.6%, SO₄²⁻: 1.2%) was suspended in 47.8 g water. 23 g of a low molecular 40% polydiallyldimethylammonium chloride was added to the suspension, which was heated and stirred intensively for 6 hours at 95° C. and then cooled. A finely divided dispersion with a pH value of 5.8 resulted.

### EXAMPLE 4

In a 500 ml double-jacket reactor with a reflux condenser and a stirrer, 305.3 g of a basic aluminum carbonate sulfate as a wet cake (Al₂O₃: 13.1%, CO₂: 1.44%, SO₄²⁻: 1.3%) was suspended in 76.6 g water. 18.08 g betaine hydrochloride was added to the suspension, which was heated and stirred intensively for 12 hours at 85° C. and then cooled. A finely divided suspension with a pH value of 4.2 resulted.

### EXAMPLE 5

In 500 ml autoclave with stirrer, 305.3 g of a basic aluminum carbonate sulfate as a wet cake (Al₂O₃: 13.1%, CO₂: 1.44%, SO₄²⁻: 1.3%) was suspended in 78.2 g water. 16.49 g of 60% ethanoic acid was added to the suspension, which was heated and stirred intensively for 2 hours at 120° C. and then cooled. A finely divided suspension with a pH value of 4.6 resulted.

### EXAMPLE 6

Into 173.2 g of the dispersion from Example 2, were stirred in order 79.6 g water, 32 g PERGLUTIN® 204 (amphoteric surface-sizing agent based on styrene/acrylate from the firm of BK GIULINI CHEMIE, of Ludwigshafen am Rhein) and 20 g of a low-molecular polydiallyldimethylammonium chloride with a solid content of 40% at room temperature. The dispersion had a viscosity of 170 mPas (Brookfield, LVTDV-II, spindle 2, 60 rpm, 20° C.).

### EXAMPLE 7

Into 100g of the dispersion from Example 4, were stirred in order 66 g enzymatically decomposed potato starch with a starch content of 29%, 16 g PERGLUTIN® 204 (amphoteric surface-sizing agent based on styrene/acrylate from the firm of BK GIULINI CHEMIE, Ludwigshafen am Rhein) and 10 g of a low-molecular polydiallyldimethylammonium chloride with a solid content of 40% at room temperature.

### EXAMPLE 8

716.4 g of a basic aluminum carbonate sulfate (Al₂O₃: 13.24%, CO₂: 1.5%, SO₄²⁻1.4%) was mixed with 4.35 g water, 15.89 g HCl 32% and 5.0 g lactic acid 85%, heated to 95° 96° C., held at this temperature and stirred intensively for 5 hours. The dispersion was cooled to 85° C., after which 15.89 g Mowiol 4-88 and 1.0 g of a defoaming agent was added to it, after which it was cooled within one hour to 60° C. During the subsequent cooling phase, which took two hours, at. 55° C. 322.7 g GILUTON® 1100/28N (polyamidoamine/epichlorohydrin resin from the firm of BK GIULINI CHEMIE, Ludwigshafen am Rhein), at 45° C., 161.3 g PERGLUTIN® 204 and at 30° C., 80.3 g of a low-molecular polydiallyldimethylammonium chloride with a solid content of 40% were stirred in. The final product was filtered using a 200μ filter.

### EXAMPLE 9

Into 50 g of the dispersion from Example 5, were stirred, in order, 15 g water, 3.2 g Mowiol 4-88 as a 20% aqueous solution and 5 g of a low-molecular polydiallyldimethylammonium chloride with a solid content of 40%, at room temperature.

### EXAMPLE 10

Into 50 g of the dispersion from Example 1, were stirred, in order, 15 g water, 3.2 g Mowiol 4-88 as a 20% aqueous solution and 5 g of a low-molecular polydiallyldimethylammonium chloride with a solid content of 40%, at room temperature.

### EXAMPLE 11

A paper sized in the mass was coated with the aid of a 10μ hand-held doctor blade with the dispersions from Examples 3, 4 and 6 to 10. The coated papers were dried for 4 mins at 105° C. and then printed with an HP Deskjet 850C printer and an Epson Stylus Photo750 printer. Visual assessment of the printed paper revealed that it was possible enormously to improve the quality in relation to wicking, bleeding, mottling, brilliance and point sharpness.

### EXAMPLE 12

50 g of the dispersion from Example 2 was treated with an Ultraturrax at 10000 rpm and then mixed with 10 g of a cationic polyurethane (Beetafin LS9081 from BIP Ltd.). A paper sized in the mass was coated with this mixture using a 50μ hand-held doctor blade, dried for 4 mins at 105° C., calendered and subsequently printed with an HP Deskjet 850C printer and an Epson Stylus Photo 750 printer. Visual assessment of the printed paper revealed that it was possible enormously to improve the quality in relation to wicking, bleeding, mottling, brilliance and point sharpness. In addition, both primary and mixed colors showed a marked luster.

1) Sulfate-containing and aluminum-containing pigments with pseudoboehmitic structural units, characterized in that they have the following empirical formula
Alₐ(O)_{b}(OH)_{c}(R)_{d}(SO₄)ₑ.yH₂O
where
a. 2b+c+xd+2e=3a and
b. a≧1, b>0, c>0, d≧0, e>0 and
c. 2b+c≧1.5a and
d. x≧1 and
e. y=0−15 and
f. R represents a monobasic or polybasic anion or mixtures of at least two anions and x is the charge on the anion, as a positive number, whereby in the case of mixtures of anions xd=x₁d₁+x₂d₂+ . . . +xₙdₙ.

2) Method for manufacturing sulfate-containing and aluminum-containing pigments with pseudoboehmitic structural units according to claim 1, characterized in that
a. a basic aluminum salt or mixtures of basic aluminum salts or
b. an aluminum hydroxide and/or a basic aluminum salt or mixtures thereof with an acid or mixtures of acids or
c. a basic aluminum salt or mixtures of basic aluminum salts in the presence of compounds bearing quaternary ammonium groups or
d. an aluminum hydroxide and/or a basic aluminum salt or mixtures thereof with an acid or mixtures of acids in the presence of compounds bearing quaternary ammonium groups or
e. a basic aluminum salt or mixtures of basic aluminum salts with a salt of an acid or with mixtures of salts of acids or
f. a basic aluminum salt or mixtures of basic aluminum salts with a salt of an acid or with mixtures of salts of acids in the presence of compounds bearing quaternary ammonium groups are thermally treated, whereby under the points a. to f. the sulfate anion is introduced into the aluminum compound via the basic aluminum salt and/or via sulfuric acid or its salts.

3.) Method for manufacturing aqueous dispersions containing sulphate-containing and aluminum-containing pigments with pseudoboehmitic structural units according to claims 1 and 2, characterized in that
a. a basic aluminum salt or mixtures of basic aluminum salts or
b. an aluminum hydroxide and/or a basic aluminum salt or mixtures thereof with an acid or mixtures of acids or
c. a basic aluminum salt or mixtures of basic aluminum salts in the presence of compounds bearing quaternary ammonium groups or
d. an aluminum hydroxide and/or a basic aluminum salt or mixtures thereof with an acid or mixtures of acids in the presence of compounds bearing quaternary ammonium groups or
e. a basic aluminum salt or mixtures of basic aluminum salts with a salt of an acid or with mixtures of salts of acids or
f. a basic aluminum salt or mixtures of basic aluminum salts with a salt of an acid or with mixtures of salts of acids in the presence of compounds bearing quaternary ammonium groups are reacted in water at raised temperature, whereby under points a. to f. the sulfate anion is introduced into the aluminum compound via the basic aluminum salt and/or via sulfuric acid or its salts.

4.) Method for manufacturing sulfate-containing and aluminum-containing pigments with pseudoboehmitic structural units according to the claims 1 to 3, characterized in that a basic aluminum carbonate sulfate with a proportion by weight of CO₂ of 1% to 20% relative to Al₂O₃ and a proportion by weight of sulfate of 5% to 20% relative to Al₂O₃ is reacted with hydrochloric acid in such a quantity that the proportion by weight of HCl is 1% to 15% relative to Al₂O₃, and an organic carboxylic acid in such a quantity that the proportion by weight of organic carboxylic acid is 0% to 50% relative to Al₂O₃, in water at temperatures of 150° C. over a period of 30 min to 720 min, whereby the Al₂O₃ content of the mixture is up to 18%, and subsequently, possibly after cooling, polydiallyldimethylammonium chloride with a proportion by weight relative to Al₂O₃ of 10% to 100% and a binder with a proportion by weight of 10% to 200% relative to Al₂O₃ and a polyamidoamine/epichlorohydrin resin with a proportion by weight of 0% to 200% relative to Al₂O₃ and a polyvinyl alcohol with a proportion by weight of 0% to 40% relative to Al₂O₃ are mixed into the suspension.

5.) Sulfate-containing and aluminum-containing pigments with pseudoboehmitic structural units according to claims 1 to 4, characterized in that as anions R they contain the anions of hydrochloric acid, phosphoric acid, nitric acid, carbonic acid, ethanoic acid, formic acid, lactic acid, glycolic acid and their mixtures.

6.) Sulfate-containing and aluminum-containing pigments with pseudoboehmitic structural units according to claims 1 to 5, characterized in that as acids, hydrochloric acid, sulfuric acid, phosphoric acid, nitric acid, amidosulfuric acid, ethanoic acid, betaine hydrochloride, formic acid, lactic acid, glycolic acid and their mixtures are used.

7.) Sulfate-containing and aluminum-containing pigments with pseudoboehmitic structural units according to claims 1 to 6, characterized in that as basic aluminum salts, basic aluminum carbonates, basic aluminum chlorides, basic aluminum sulfates, basic aluminum phosphates, basic aluminum nitrates, basic aluminum acetates, basic aluminum formiates, basic aluminum carbonate chlorides, basic aluminum carbonate sulfates, basic aluminum carbonate phosphates, basic aluminum carbonate nitrates, basic aluminum carbonate acetates, basic aluminum carbonate formiates and their mixtures are used.

8.) Sulfate-containing and aluminum-containing pigments with pseudoboehmitic structural units according to claims 1 to 7, characterized in that as salts of acids, the Na and/or K and/or Ca and/or Mg and/or ammonium salts are used.

9.) Sulfate-containing and aluminum-containing pigments with pseudoboehmitic structural units according to claims 1 to 8, characterized in that as compounds bearing quaternary ammonium groups, homopolymers and/or copolymers of diallyldimethylammonium chloride, dimethylamine/epichlorohydrin condensation products, betaine, polyamidoamine/epichlorohydrin resins and their mixtures are used.

10.) Sulfate-containing and aluminum-containing pigments with pseudoboehmitic structural units according to claims 1 to 9, characterized in that the thermal treatment takes place in the presence of polycations, polyhydroxy compounds, polyethers, polyamines or their salts, binders and mixtures of these.

11.) Sulfate-containing and aluminum-containing pigments with pseudoboehmitic structural units according to claims 1 to 10, characterized in that the thermal treatment takes place in the presence of additional substances.

12.) Sulfate-containing and aluminum-containing pigments with pseudoboehmitic structural units according to claims 1 to 11, characterized in that they are used in combination with binding agents.

13.) Sulfate-containing and aluminum-containing pigments with pseudoboehmitic structural units according to claims 1 to 12, characterized in that they are used in combination with pigments.

14.) Sulfate-containing and aluminum-containing pigments with pseudoboehmitic structural units according to claims 1 to 13, characterized in that they are used in combination with polycations, polyhydroxy compounds, polyethers, polyamines or their salts and mixtures of these.

15.) Use of the sulfate-containing and aluminum-containing pigments with pseudoboehmitic structural units according to claims 1 to 14 as coating material.

16.) Use of the sulfate-containing and aluminum-containing pigments with pseudoboehmitic structural units according to claims 1 to 15 as coating material for paper.

17.) Use of the sulfate-containing and aluminum-containing pigments with pseudoboehmitic structural units according to claims 1 to 16 as filler for paper making.
